(19) United States
(12) Patent Application Publication
(10) Pub. No.: US 2024/0338662 A1
(43) Pub. Date: Oct. 10, 2024

(54) METHODS FOR AUTOMATED WORK ORDER NOT-TO-EXCEED (NTE) LIMIT OPTIMIZATION AND DEVICES THEREOF

(71) Applicant: Jones Lang LaSalle IP, Inc., Chicago, IL (US)

(72) Inventors: Carlos Miranda DURAND, Euless, TX (US); Jaxon GUMMI, Castle Rock, CO (US); John WATKINSON, Allen, TX (US); Simon LEE, Grapevine, TX (US)

(21) Appl. No.: 18/130,598

(22) Filed: Apr. 4, 2023

(51) Int. Cl. G06Q 10/20

(52) U.S. Cl. CPC G06Q 10/20

(57) ABSTRACT

Methods, non-transitory computer readable media, and work order analysis server devices are disclosed that train a machine learning model based on historical invoice data and target quote rates. A baseline quote rate for an enterprise is generated based historical invoices, quotes, and NTE values. A target quote rate is generated based on the baseline quote rate, tolerance data for the enterprise, and first business rule(s). The tolerance data includes a quantitative indication of an efficiency preference of the enterprise with respect to work order review. The machine learning model is then applied to the target quote rate and work order data extracted from an NTE limit request received from the enterprise to generate a model-recommended NTE limit. A prescribed NTE limit is returned in response to the NTE limit request, which is generated based on an application of second business rule(s) to the model-recommended NTE limit.

### FIELD

This technology generally relates to facility management systems for automated service provider work order processing and, more particularly, to methods and devices for automated work order not-to-exceed (NTE) limit optimization.

### BACKGROUND

In traditional facility maintenance workflows, organizations attempt to eliminate the need to manage their not-to-exceed (NTE) limits for work orders by setting arbitrary limits on all vendor invoices or cost estimates. This workflow presents organizations with a set of challenges because the process of setting NTE limits is manual and tedious, NTE limits are often not updated for long periods of time, and NTE limits are not set based on any empirical data and are therefore either too high or too low.

When NTE limits are set too low, current automated review processes flag an increased number of invoices or cost estimates for manual review and approval, creating significant friction in the work order process. When NTE limits are set too high, vendors may quote work higher or charge more than the actual cost of providing a service, but still below the NTE limit, in order to increase revenue while avoiding scrutiny associated with a manual review.

Thus, some organizations are spending excessively on vendor invoices or cost estimates, because NTE limits were set too high and were susceptible to vendor abuse. Other organizations are investing significant time manually reviewing and approving too many invoices or cost estimates, because NTE limits were set too low. Accordingly, work order processing is currently an inefficient and ineffective automated process within facility management systems.

### SUMMARY

A method for automated work order not-to-exceed (NTE) limit optimization is disclosed along with non-transitory computer readable media, and work order analysis server devices that are configured to perform the method. Thus, the method can be implemented by one or more work order analysis server devices that include memory including programmed instructions stored thereon and one or more processors configured to execute the stored programmed instructions to perform the method. In other examples, a non-transitory computer readable medium having stored thereon instructions is disclosed that includes executable code that, when executed by one or more processors, causes the one or more processors to perform the method.

In some examples, the method includes training a machine learning model based on historical invoice data and a plurality of potential target quote rates for a plurality of enterprises and future scenarios. The historical invoice data includes an amount and associated contextual data for a plurality of invoices issued to the enterprises by service providers in response to service requests. A baseline quote rate for an enterprise is generated based on a plurality of historical invoices, quotes, and NTE values associated with the enterprise. A target quote rate for the enterprise is then generated based on the baseline quote rate, received tolerance data for the enterprise, and a set of business rules. The received tolerance data includes a quantitative indication of an efficiency preference of the enterprise with respect to work order review.

The trained machine learning model is then applied to the target quote rate and work order data extracted from an NTE limit request received from the enterprise to generate a model-recommended NTE limit. A prescribed NTE limit is returned in response to the NTE limit request to facilitate automated processing of an electronic vendor quote. The prescribed NTE limit is generated based on an application of one or more stored business rules to the model-recommended NTE limit.

This technology provides a number of advantages including methods, non-transitory computer readable media, and work order analysis server devices that advantageously leverage a machine learning model trained on historical invoice data to generate optimized NTE limits for work orders. This technology applies tolerance data provided by an enterprise to invoice amount distributions generated as a result of the application of the machine learning model to determine an optimized baseline quote rate.

The prescribed NTE resulting from the application of stored business rules to the baseline quote rate facilitates more effective and efficient automated processing of vendor quote data in accordance with enterprise priorities. Accordingly, this technology optimizes resource utilization on, and improves the functioning of, facility management systems while providing a technical solution to the technical problem of generating and applying effective NTE limits in automated work order processing facility management systems.

### BRIEF DESCRIPTION OF THE DRAWINGS

FIG. 1 is a block diagram of an exemplary network environment with a work order analysis server device;

FIG. 2 is a block diagram of an exemplary work order analysis server device;

FIG. 3 is a flowchart of an exemplary method for automated work order and service provider quote processing to facilitate automated enterprise facility management;

FIG. 4 is an exemplary configuration data interface;

FIG. 5 is an exemplary tolerance data interface;

FIG. 6 is an exemplary table of exemplary tolerance data and associated tolerance data interface field;

FIG. 7 is a flowchart of an exemplary method for training and using machine learning models to optimize generation and application of work order NTE limits for automated enterprise facility management; and

FIG. 8 depicts an exemplary invoice amount conditional probability density function.

### DETAILED DESCRIPTION

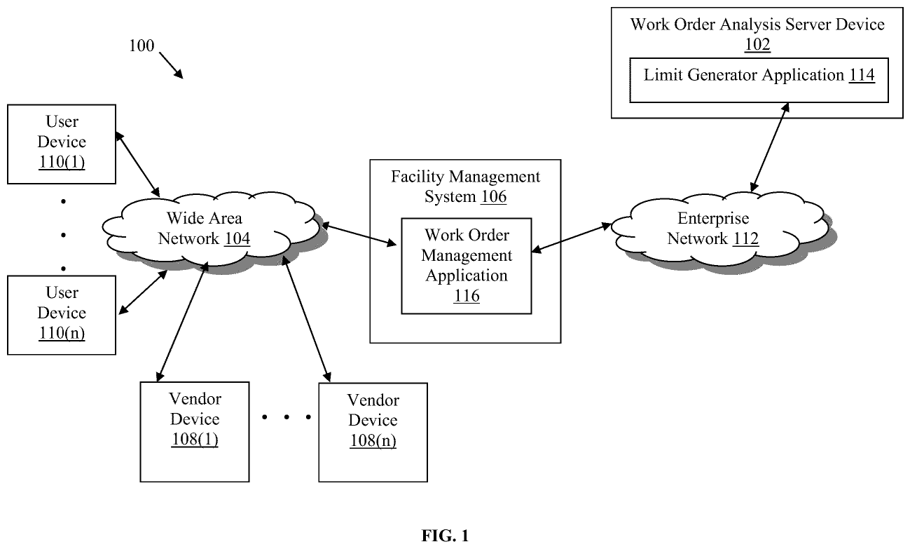

Referring to FIG. 1, an exemplary network environment 100 is illustrated that includes a work order analysis server device 102 coupled, via an enterprise network 112, to a facility management system 106, which is coupled to vendor devices 108(1)-108(n) and user devices 110(1)-110(n) by a wide area network (WAN) 104. The network environment 100 may include other network devices such as one or more routers or switches, for example, which are known in the art and thus will not be described herein. This technology provides a number of advantages including methods, non-transitory computer readable media, and work order analysis server devices that more effectively determine, and automatically apply, work order not-to-exceed (NTE) limits based on a trained machine learning model in order to facilitate more efficient processing of work orders and associated service provider quotes or invoices.

In this particular example, the user devices 110(1)-110(n), facility management system 106, vendor devices 108(1)-108(n), and work order analysis server device 102 are disclosed in FIG. 1 as dedicated hardware devices. However, one or more of the user devices 110(1)-110(n), facility management system 106, vendor devices 108(1)-108(n), or work order analysis server device 102 can also be implemented in software within one or more other devices in the network environment 100. As one example, the work order analysis server device 102, as well as any of its components or applications, can be implemented as software executing on the facility management system 106, and many other permutations and types of implementations and network topologies can also be used in other examples.

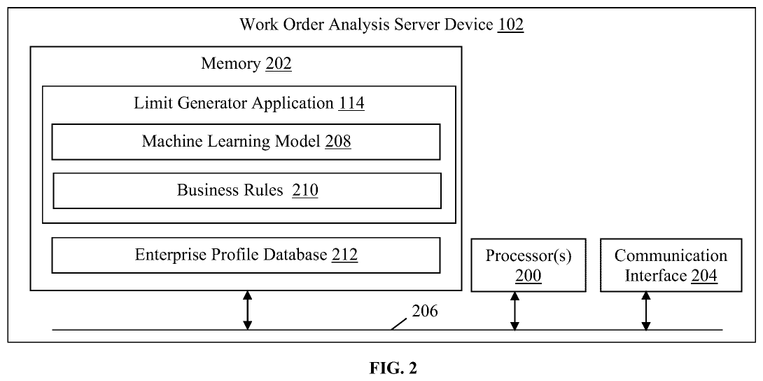

Referring to FIGS. 1-2, the work order analysis server device 102 of the network environment 100 may perform any number of functions, including executing a limit generator application 114 that provides an endpoint to the work order management application 116 (e.g., Corrigo Enterprise™ offered by Jones Lang LaSalle Incorporated of Chicago, IL) executed by the facility management system 106 for NTE limit requests, and processes those requests to generate and return a prescribed NTE limit, as described and illustrated in more detail below. The work order analysis server device 102 in this example includes processor(s) 200, a memory 202, and a communication interface 204, which are coupled together by a bus 206, although the work order analysis server device 102 can include other types or numbers of elements in other configurations.

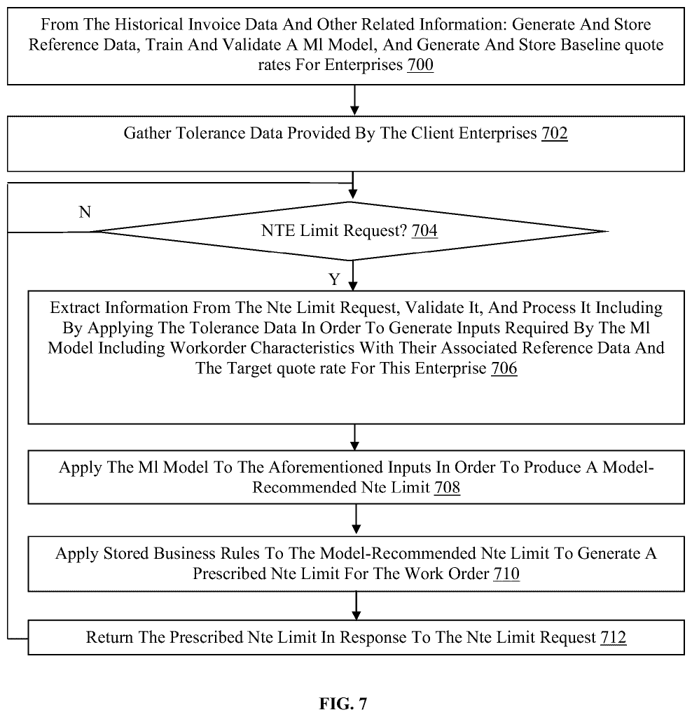

The processor(s) 200 of the work order analysis server device 102 may execute programmed instructions stored in the memory 202 of the work order analysis server device 102 for any number of the functions described and illustrated herein (e.g., with reference to FIG. 7). The processor(s) 200 may include one or more central processing units (CPUs), graphics processing units (GPUs),, and/or general purpose processors with one or more processing cores, for example, although other types of processor(s) can also be used.

The memory 202 of the work order analysis server device 102 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

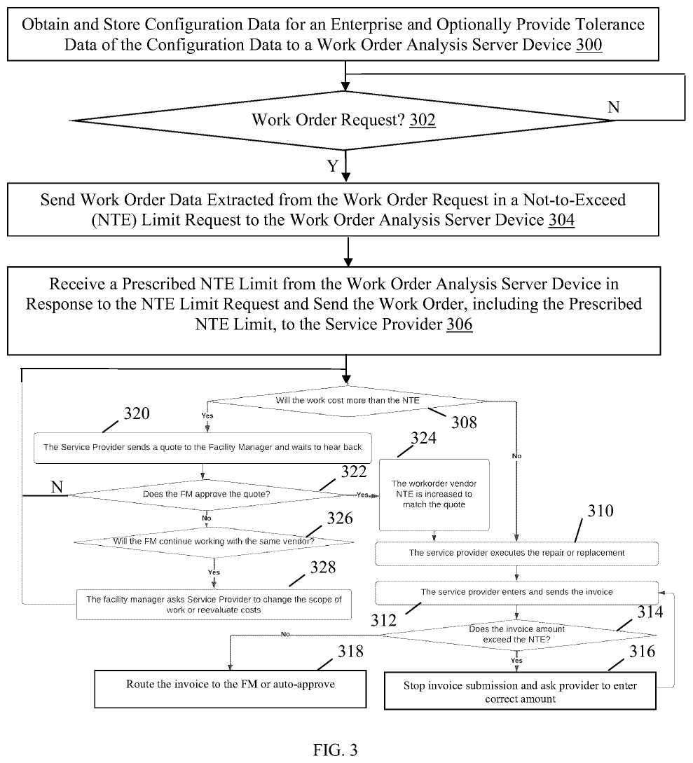

Accordingly, the memory 202 can store applications that can include computer executable instructions that, when executed by the work order analysis server device 102, cause the work order analysis server device 102 to perform actions, such as to transmit, receive, or otherwise process network messages and requests, for example, and to perform other actions described and illustrated below with reference to FIGS. 3-8. The application(s) can be implemented as components of other applications, operating system extensions, and/or plugins, for example.

Further, the application(s) may be operative in a cloud-based computing environment with access provided via a software-as-a-service model. The application(s) can be executed within or as virtual machine(s) or virtual server(s) that may be managed in a cloud-based computing environment. Also, the application(s), and even the work order analysis server device 102 itself, may be located in virtual server(s) running in a cloud-based computing environment rather than being tied to specific physical network computing devices. Also, the application(s) may be running in virtual machines (VMs) executing on the work order analysis server device 102 and managed or supervised by a hypervisor.

In this particular example, the memory 202 includes the limit generator application 114, which includes a machine learning model 208 and business rules 210, and an enterprise profile database 212. The enterprise profile database 212 stores tolerance data received from the facility management system 106 via the user devices 110(1)-110(n). The tolerance data includes a quantitative indication of an efficiency preference of an enterprise with respect to work order review. The quantitative indication can be a percentage, such as a percentage of quotes for work orders that the enterprise is willing to review manually, although other types of tolerance data can also be used in other examples. The enterprise profile database 212 also stores various data representations (e.g., profile vectors or embeddings) of clients, assets, maintenance tasks, geographic areas, and other entities whose information is used in the training and the application of the machine learning model 208.

The limit generator application 114 trains the machine learning model 208 on historical invoice data, which can be stored in the memory 202 and/or obtained from third party server(s) (not shown), for example. The historical invoice data can include an amount and associated contextual data for a plurality of invoices issued to a plurality of enterprises by service providers in response to service requests. For example, the contextual data can include an indication of a specialty (e.g., HVAC), a geographic area (e.g., New York City), a season, an equipment model, maintenance task(s), and/or company attribute(s), although other types of data can also be included in the contextual data.

In some examples, the historical invoice data and related work order data is processed or transformed as part of training and applying the machine learning model 208. For example, the limit generator application 114 can generate data representations (e.g., profile vectors or embeddings), group or cluster similar work order records, and/or generate training datasets that capture various points of the empirical conditional distributions of the historical vendor invoice total amount, for example, and other types of transformations of the historical invoice data can also be used.

Additionally, the limit generator application 114 trains the machine learning model 208 on multiple potential target quote rates in order to support various future scenarios that may occur during operations. The limit generator application 114 is configured to then use a baseline quote rate and tolerance data and other settings for an enterprise to generate a target quote rate in response to an NTE limit request received from the enterprise via the facility management system 106. The limit generator application 114 can then apply the trained machine learning model 208 to the target quote rate and the work order data extracted from the received NTE limit request to generate a model-recommended NTE limit.

The business rules 210 stored in the memory 202 are then applied to the model-recommended NTE limit to generate a prescribed NTE limit, which corresponds with an optimized NTE limit for the enterprise for the particular work order associated with the NTE limit request. Accordingly, the business rules 210 may require some interventions such as the increase, decrease, capping, flooring, rounding, or overriding of some model-recommended NTE limits according to rules established for all enterprises and all service providers or for particular enterprise(s) or service provider(s), for example, as explained in more detail below. With the prescribed NTE limit generated by these business rules 210, the facility management system 106 can more effectively and automatically process vendor quotes and invoices in an optimized manner to achieve enterprise objectives.

In some examples, the business rules 210 are used to facilitate statistical experimentation capabilities (e.g., A/B testing). The design of experiments is included in the configuration of the business rules 210. At the time a first NTE limit request is received for each work order, the work order is identified and placed in a specific treatment group or control group. The interventions mentioned above may vary with the group. The work order analysis server device 102 tracks all the actions and events in the life of the work order, including the submissions of quotes and invoices, for each group. This capability enables measuring the business impact (e.g., monetary savings, quote rate reductions, or other gains), learning the impact of NTE values on vendor behaviors (including behavioral economics questions), and further improvement of the work order analysis server device 102 itself.

The communication interface 204 of the work order analysis server device 102 operatively couples and communicates between the work order analysis server device 102 and facility management system 106, which are coupled together at least in part by the enterprise network 112, although other types or numbers of communication networks or systems with other types or numbers of connections or configurations to other devices or elements can also be used.

By way of example only, the WAN 104 and/or enterprise network 112 can use TCP/IP over Ethernet and industry-standard protocols, although other types or numbers of protocols or communication networks can be used. The WAN 104 and/or enterprise network 112 in this example can employ any suitable interface mechanisms and network communication technologies including, for example, Ethernet-based Packet Data Networks (PDNs).

While the work order analysis server device 102 is illustrated in this example as including a single device, the work order analysis server device 102 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the work order analysis server device 102. Additionally, one or more of the devices that together comprise the work order analysis server device 102 in other examples can be standalone devices or integrated with one or more other devices or apparatuses.

The facility management system 106 of the network environment 100 includes one or more processors, a memory hosting the work order management application 116, and a communication interface, which are coupled together by a bus or other communication link, although other numbers and types of network devices could be used. The facility management system 106 in this example executes the work order management application 116, which is configured to process work order requests submitted by the user devices 110(1)-110(n) and generate NTE limit requests (e.g., API requests) to the limit generator application 114.

The work order management application 116 is further configured to publish service requests to the vendor devices 108(1)-108(n), receive quote data in response to the services requests, and automatically process the quote data according to prescribed NTE limits received from the limit generator application 114 in response to NTE limit requests. Based on the processing of the quote data, the work order management application 116 can send an engagement request to one of the vendor devices 108(1)-108(n) and/or quote data to one of the user devices 110(1)-110(n) for manual review. The operation of the work order management application 116 will be described and illustrated in more detail below with reference to FIG. 3.

Although the exemplary network environment 100 with the user devices 110(1)-110(n), facility management system 106, vendor devices 108(1)-108(n), and work order analysis server device 102, WAN 104, and enterprise network 112 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the user devices 110(1)-110(n), facility management system 106, vendor devices 108(1)-108(n), or work order analysis server device 102, for example, may be configured to operate as virtual instances on the same physical machine. In other words, one or more of the user devices 110(1)-110(n), facility management system 106, vendor devices 108(1)-108(n), or work order analysis server device 102 may operate on the same physical device rather than as separate devices communicating through WAN 104 and/or enterprise network 112. Additionally, there may be more or fewer user devices, facility management systems, vendor devices, or work order analysis server devices than illustrated in FIG. 1.

The examples of this technology may also be embodied as one or more non-transitory computer readable media having instructions stored thereon, such as in the memory 202, for one or more aspects of the present technology, as described and illustrated by way of the examples herein. The instructions in some examples include executable code that, when executed by one or more processors, such as the processor(s) 200, cause the processors to carry out steps necessary to implement the methods of the examples of this technology that are described and illustrated herein.

Referring to FIG. 3, a flowchart of an exemplary method for automated work order and service provider quote processing to facilitate automated enterprise facility management is illustrated. In step 300 in this example, the facility management system 106 obtains and stores configuration data for an enterprise and including the tolerance data that will be used by the work order analysis server device 102 to prescribe NTE limits.

The tolerance data can include a quantitative indication of an efficiency preference of the enterprise with respect to work order review. Accordingly, the tolerance data corresponds with a strategy for the enterprise such that it reflects whether the enterprise is more concerned with saving money with respect to vendor invoices or saving time/resources in manually reviewing vendor quote data and solving associated problems. For example, an enterprise can set a strategy of “administrative time savings” and a tolerance level of “extra large” indicating that it only wants to receive cost estimates or quotes for a small percentage of work orders, with the remainder of the vendor invoices automatically approved by the facility management system 106 without needing a prior quote. This strategy reflects a preference of the enterprise to save in administrative labor costs or to accelerate workorder completion times and will result in relatively high prescribed NTE limits, as explained in more detail below.

In another example, an enterprise can set a strategy of saving money with respect to vendor invoices and set a tolerance level of “extra large” indicating that it wants to receive cost estimates or quotes for manual review for most vendor work orders, with only very few being automatically approved by the facility management system 106 without a quote. This strategy reflects a preference of the enterprise to save in vendor maintenance costs, even at the expense of higher administrative workload and completion times and will result in relatively low prescribed NTE limits. In yet other examples, the work order analysis server device 102 may be activated but leaving the tolerance parameters with their default values (“status quo”) in which case the work order analysis server device 102 will optimize prescribed NTE limits but seek to maintain the same rate of quotes than in the past (e.g. keep the target quote level equal to the baseline quote level).

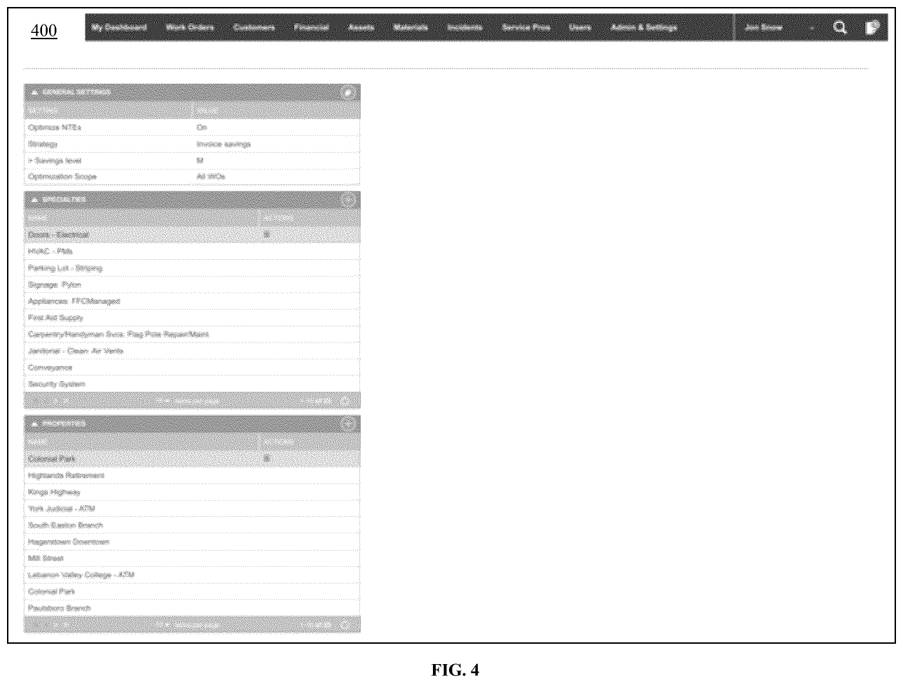

Referring to FIG. 4, an exemplary configuration data interface 400 is illustrated. In this example, the configuration data interface 400 can be provided by the work order management application 116 to one of the user devices 110(1) associated with an enterprise. The configuration data interface 400 facilitates input by a user of the one of the user devices 110(1) of configuration data, which in this example includes general settings, specialties, and properties, although other types of configuration data can also be input via the configuration data interface 400 in other examples.

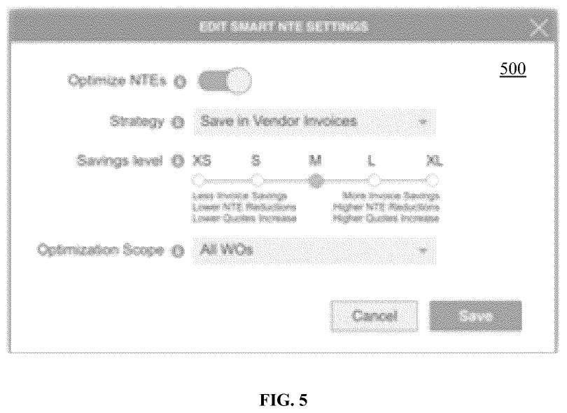

The general settings facilitating input of the tolerance data via a strategy field, as described and illustrates in more detail below with reference to FIG. 5. In this example, the specialties relate to service categories for which the facility management system 106 will communicate with the work order analysis server device 102 to obtain an associated NTE. Specialties can include, HVAC, appliances, and security system, although another number or type of specialties can be provided for selection via the configuration data interface 400. The properties can relate to the physical properties or facilities associated with the enterprise for which related work orders will be processed according to the technology described and illustrated herein.

Referring to FIG. 5, an exemplary tolerance data interface 500 is illustrated. The tolerance data interface 500 can be presented to the one of the user devices 110(1)-10(n) by the work order management application 116 upon selection of a link or button in the general settings of the configuration data interface 400, for example. In this particular example, the tolerance data interface 500 includes an input to toggle whether optimized NTEs are to be used at all, a strategy input, a savings level input, and a optimization scope input (e.g., all work orders or only an indicated subset), although the tolerance data interface 500 can include other inputs in other examples.

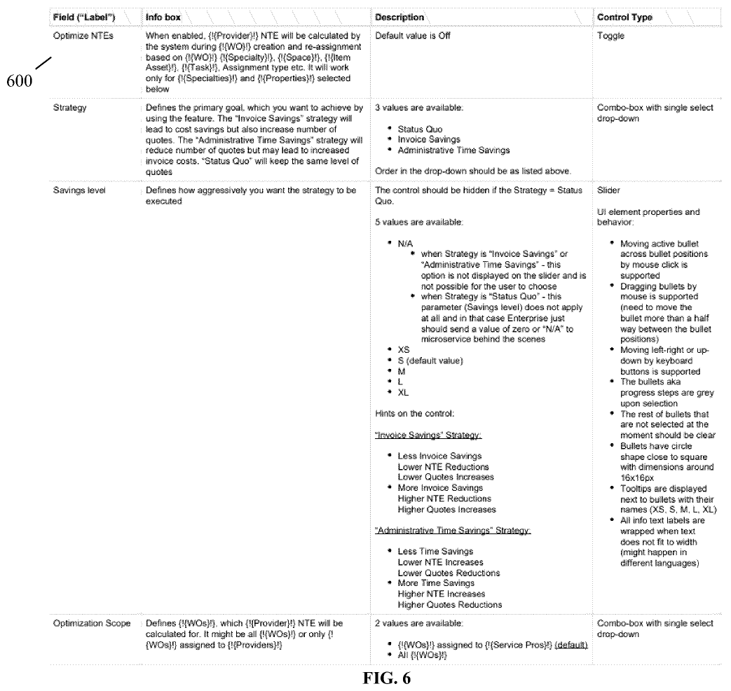

Referring to FIG. 6, a table 600 of exemplary tolerance data and associated tolerance data interface 500 fields is illustrated. In the table 600, various exemplary values of the inputs provided via the tolerance data interface 500 are illustrated. For example, three values may be available for the strategy input, which are status quo, invoice savings, or administrative time savings.

The savings input in this example relates to how aggressive the enterprise would like the strategy to be executed. The savings input in this example has five values, although other levels of granularity for quantifying the savings desired by an enterprise can also be used. The strategy and savings level inputs of the configuration data comprise the tolerance data in this example and impact the baseline and/or prescribed NTE limits generated for a particular vendor invoice for the enterprise, as described and illustrated in more detail below.

Referring back to FIG. 3, in step 302, the facility management system 106 determines whether a work order has been received. The work order can be input to the work order management application 116 via an interface provided to one of the user devices 110(1)-110(n), for example, as part of creating a new work order. In another example, the reassignment of a work order to a different maintenance provider can trigger the request received in step 302. Accordingly, the work order can include work order data associated with the problem for which a service provider is required. If the facility management system 106 determines that a work order request has not been received, then the No branch is taken back to step 302 and the facility management system 106 effectively waits for a work order request to be received. However, if the facility management system 106 determines that a work order request has been received, then the Yes branch is taken to step 304.

In step 304, the facility management system 106 sends the work order data extracted from the work order request in an NTE limit request to the work order analysis server device 102. For example, the work order data can indicate that a heater is not functioning in a particular property associated with the enterprise, requiring an HVAC service provider, although other types of work order data can also be extracted in other examples. The NTE limit request can be processed by the work order analysis server device 102 as described and illustrated in detail below with reference to FIG. 7.

In step 306, the facility management system 106 receives a prescribed NTE limit from the work order analysis server device 102 in response to the NTE limit request sent in step 304. The prescribed NTE limit request is generated by the work order analysis server device 102 and includes a monetary value below which a vendor invoice or cost estimate will be automatically approved by the facility management system 106 and above which the facility management system 106 will escalate to one of the user devices 110(1)-110(n) for manual review, as explained in more detail below.

Thereafter, the facility management system 106 sends the prescribed NTE limit to one of the vendor devices 108(1)-108(n) in a service request that includes portion(s) of the work order data. In this example, the facility management system 106 can process the extracted work order data to generate a service request, which may indicate a location a service is required and a specialty associated with the required service, among other information. The service request can be published by the facility management system 106 via a request for proposal (RFP) portal that is public-facing or automatically communicated via stored contact information to particular vendor(s) based on a correlation with the work order data and stored vendor information, for example. In other examples, the prescribed NTE limit can be communicated to one of the use devices 110(1)-110(n), which can then, at the direction of a user, send the service request with the prescribed NTE limit to one or more of the vendor devices 108(1)-108(n). Other methods for generating and communicating service requests, and obtaining quote data, can also be used in other examples.

In step 308, the vendor determines the cost of the work associated with the service request and whether that cost will exceed the prescribed NTE limit identified in the service request. If the vendor determines that the cost of the work will not exceed the prescribed NTE limit, then the No branch is taken to step 310.

In step 310, the vendor or service provider executes the repair or replacement, or otherwise performs the work associated with the service request. In this exemplary iteration, the user of the one of the vendor devices 108(1)-108(n) determined that it could perform the service for less than the prescribed NTE limit in the service request, and the facility management system 106 does not receive a quote from the vendor. In other words, if a vendor recipient of the service request determines that it can perform the work without exceeding the prescribed NTE limit identified therein, the vendor can proceed to complete the work without sending quote data.

In step 312 in this example, subsequent to performing the work, the vendor or service provider enters and sends the invoice for the work that is responsive to the service request. The vendor can use one of the vendor devices 108(1)-108(n) to communicate with the facilitate management system 106 (e.g., via a provided interface) to submit the associated invoice, for example, although other methods of entering and/or sending the invoice can also be used in other examples.

In step 314, upon receipt of the invoice, the facility management system 106 determines whether the amount of the invoice exceeds the prescribed NTE limit included in the service request. If the facility management system 106 determines that the invoice amount exceeds the prescribed NTE limit, then the Yes branch is taken to step 316. In step 316, the facility management system 106 stops or prevents submission of the invoice and asks the service provided to enter the correct amount (i.e., an amount below the prescribed NTE limit). The request to enter the correct amount can be communicated to the associated one of the vendor devices 108(1)-108(n), for example. Accordingly, steps 314-316 provide an additional check that constrains the invoice cost to the enterprise and confirms the cost is below the prescribed NTE limit below which the vendor implicitly agreed to perform the related work. However, if the facility management system 106 determines in step 314 that the invoice amount does not exceed the prescribed NTE limit, then the No branch is taken to step 318

In step 318, the facility management system 106 routes the invoice to a facility manager (e.g., a user of one of the user devices 110(1)-100(n)) or automatically approves the invoice and submits it to an external system for payment, for example. Other methods for routing or processing the invoice can also be used in other examples.

Accordingly, subsequent to completing the work responsive to the service request, the vendor can send an invoice, which is automatically reviewed to confirm the invoice amount does not exceed the prescribed NTE limit, approved, and submitted to a payment process. In such an exemplary iteration, the prescribed NTE limit remains unchanged subsequent to engagement of the vendor and payment of the invoice. However, if the vendor or service provider determines in step 308 that the work will cost more than the prescribed NTE limit, then the Yes branch is taken from step 308 to step 320.

In step 320, the vendor or service provider sends a quote to the facility manager (e.g., a user of one of the user devices 110(1)-110(n)) and waits for a response. The vendor can send the quote via the facility management system 106 in some examples. In these examples, the facility management system 106 sends the quote data to one of the user devices 110(1)-110(n) for manual review by a user associated with the enterprise. In some examples, the work order management application 116 can provide an interface to the one of the user devices 110(1)-110(n) that includes an indication of vendor quote(s) that requires manual review of the associated quote data and facilitates input of a decision by the user, although other methods for facilitating the manual review can also be used in other examples.

Accordingly, in this particular iteration, the vendor that received the service request estimates that the cost to complete the work will exceed the prescribed NTE limit in the service request, and therefore submits quote data including a monetary amount, which is obtained by the facility management system 106 in step 320 with the quote. The quote data is obtained from one of the vendor devices 108(1)-108(n) in response to the service request because the prescribed NTE limit is lower than an amount in the quote data for which the associated vendor has determined it can complete the required work.

In step 322, the facility management system 106 determines whether the vendor quote associated with the quote data is approved by the facility manager user of the one of the user devices 110(1)-110(n) associated with the enterprise following a manual review. If the facility management system 106 determines that the vendor quote is approved, then the Yes branch is taken to step 324 in this example.

In step 324, the facility management system 106 increases the work order vendor prescribed NTE limit to match the quote. Thus, if the vendor quote is approved, then the prescribed NTE limit is effectively overridden in this particular example. The facility management system 106 then proceeds to steps 310-318, as described in more detail above. However, if the facility management system 106 determines in step 322 that the facility manager user of the one of the user devices 110(1)-110(n) did not approve the quote, then the No branch is taken to step 326.

In step 326, the facility management system 106 optionally determines whether the facility manager user is willing to continue working with the same vendor that provided the quote that exceeded the prescribed NTE limit. The facility management system 106 can make the determination in step 326 via an interface provided to the one of the user devices 110(1)-110(n) or via an explicit request message sent to the one of the user devices 110(1)-110(n), for example. If the facility management system 106 determines that the facility manager user does not wish to continue working with the same vendor, then the No branch is taken back to step 308 and another quote from another vendor is received. However, if the facility management system 106 determiners in step 326 that the facility manager user is willing to continue working with the same vendor, then the Yes branch is taken to step 328.

In step 328, the facility management system 106 optionally sends a rejection message to the one of the vendor devices 108(1)-108(n) from which the quote data originated in order to request that the vendor or service provider change the scope of work or reevaluate the costs, optionally to result in a lower quote that is below the prescribed NTE limit. The rejection message can include an indication that the amount in the quote data was too high, provide a link to a resubmission of another vendor quote, and/or include other data relating to the rejection of the vendor quote. Optionally, the enterprise (e.g., a user of one of the user devices 110(1)-110(n)) can ask the vendor to repair instead of replace equipment, use cheaper materials, or for other changes to the service request. The vendor can then decide whether to send another quote or accept to do the work for an amount under the prescribed NTE limit in a subsequent iteration.

Subsequent to sending the rejection message, the facility management system 106 can proceed back to step 308 and extract quote data from a quote received from another one of the vendor devices 108(1)-108(n). In some examples, the vendor quotes can be queued and the order of processing can be determined after expiration of a time period and based on the application of stored rules (e.g., relating to preference for engaging particular vendors or a ranking or amount in the associated quote data). In other examples, the service request can be resent in a subsequent iteration to another one of the vendor devices 108(1)-108(n).

Irrespective of whether the quote was approved, the facility management system 106 can optionally provide feedback data to the limit generator application 114, which can use the feedback data to adjust prescribed NTE limit(s) provided in subsequent iterations for future work orders sharing the same or similar characteristics as the current work order, for example. In other examples, steps 302-328 can be performed in parallel for any number of work order requests associated with an enterprise, and/or one or more of steps 300-328 can also be performed in a different order in yet other examples.

Referring to FIG. 7, a flowchart of an exemplary method for training and using machine learning models to optimize generation and application of work order NTE limits for automated enterprise facility management is illustrated. In step 700 in this example, the work order analysis server device 102 generates and stores the machine learning model 208 trained and validated on historical invoice data other related or contextual information, and/or reference data (e.g., (profile vectors or embeddings) target quote rate for each of a plurality of enterprises in order to facilitate modeling a conditional distribution of invoice amounts subject to key work order attributes. Additionally, the work order analysis server device 102 generates and stores baseline quote rates for each of the enterprises. The baseline quote rates can be determined from historical invoices for the enterprise received from the facility management system 106 correlated with work order, although other methods for determining the baseline quote rates can also be used.

[symbol]

In some examples, the historical invoice data can be obtained from a third party repository of invoice data for a plurality of enterprises. In these examples, the historical invoice data can be industry benchmark data. In other examples, the historical invoice data can be obtained from a local repository maintained by the work order analysis server device 102 based on vendor quotes and/or invoices obtained (e.g., along with NTE limit requests) from the facility management system 106 associate with a plurality of enterprises.

The historical invoice data can include amount, specialty, geography, temporal data (e.g., day of the week, year, and/or season), or any other data that corresponds with a category of the work order data extracted from a work order request as described above with reference to step 304 of FIG. 3. Additionally, the machine learning model 208 can be generated via supervised or semi-supervised learning. Additionally, unsupervised learning algorithms, deep learning models (such as a convolutional neural network (CNN) or transformer models, for example), may be applied to the NTE recommendation model itself 208 or to the pre-processing of the workorder data (included but not limited to structured data from the CMM system, text descriptions, images, sensor data, and other collected field data) to generate inputs for the NTE recommendation model 208.

In step 702, the work order analysis server device 102 obtains and stores (e.g., in the enterprise profile database 212) tolerance data for at least one enterprise based on historical invoice data and/or NTE limit data for the enterprise. In this example, the work order analysis server device 102 generates the tolerance data, although the tolerance data can be obtained directly from the enterprise (e.g., from the facility management system 106) (and optionally stored in the enterprise profile database 212 along with any enterprise-specific business rules obtained from the enterprise). To generate the tolerance data, the work order analysis server device 102 can compare historical invoice data (e.g., industry benchmark data) to established NTE limit data (e.g., NTE limits correlated with various sets of work order data) for the enterprise to determine whether the enterprise has effectively expressed a preference for time or monetary savings.

For example, if the established NTE limits for an enterprise for a majority of specialties in the enterprise's geographic area are lower by a relatively large margin than the benchmark historical invoice data, the enterprise may prefer and have a higher tolerance for lower NTE limits that may save more money but will require more manual review of received vendor quotes that exceed the NTE limits. Accordingly, while the established NTE limit data may include NTE limits that are suboptimal, the NTE limit data can inform the tolerance data used in the optimizations described and illustrated herein.

In step 704, the work order analysis server device 102 determines whether an NTE limit request has been received. The NTE limit request can be received from the work order management application 116 via an endpoint or API provided by the limit generator application 114, for example. Accordingly, the NTE limit request could have been sent by the work order management application 116 as described above with reference to step 304 of FIG. 3. If the work order analysis server device 102 determines that an NTE limit request has not been received, then the No branch is taken back to step 704 and the work order analysis server device 102 effectively waits to receive an NTE limit request. However, if the work order analysis server device 102 determines in step 704 that an NTE limit request has been received, then the Yes branch is taken to step 706.

In step 706, the work order analysis server device 102 extracts information from the NTE limit request, validates it, and processes it, including by applying the tolerance data in order to generate inputs required by the machine learning model 208, including workorder characteristics with their associated reference data and the target quote rate for the enterprise associated with the work order request. The target quote rate is generated by applying a set of pre-processing business rules (e.g., within business rules 210) to the baseline quote rates derived for the enterprise and the tolerance data configured by the enterprise obtained in step 702.

In step 708, the work order analysis server device 102 applies the stored machine learning model 208 to inputs including work order characteristics, the target quote rate generated in step 706, work order data extracted from the received NTE limit request, and associated reference data, to generate a model-recommended NTE limit. Accordingly, the target quote rate is used by the machine learning model to tune the model-recommended NTE limit according to preferences and historical activity of the particular enterprise relating to saving money as compared to saving time processing vendor quotes.

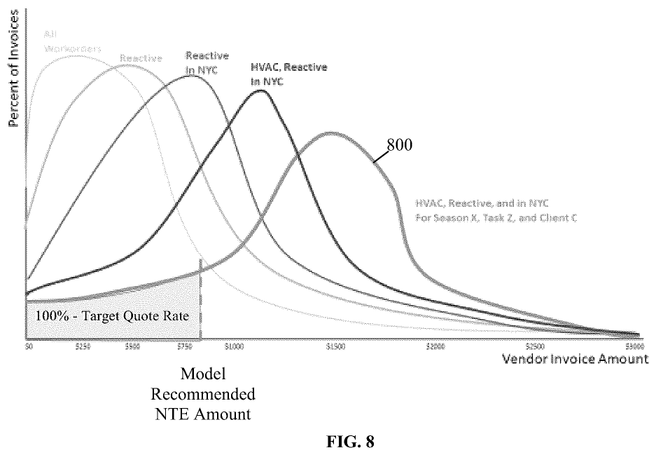

Referring to FIG. 8, an exemplary invoice amount conditional probability density function 800 is illustrated. In this example, the density function 800 represents the probability distribution of vendor spend amounts for a given group historical work orders in the relatively expensive HVAC trade, in the relatively expensive New York City (NYC) geographic area, and with other relatively expensive traits (expensive task, high-demand season, etc.) The expensive nature of this particular group of workorders caused a shift to the right on the X or vendor invoice amount axis compared to the density function for all work orders, reactive services, reactive services in NYC, and reactive HVAC services in NYC.

The model-recommended NTE is the value on the X axis (e.g. the vendor invoice amount value) that has a cumulative distribution function (e.g. an area under the invoice amount distribution curve 800) that is equal to 100%—the generated target quote rate for the enterprise.

Referring back to FIG. 7, in step 710, the work order analysis server device 102 applies stored business rules 210 to the model-recommended NTE limit to generate a prescribed NTE limit for the work order. The business rules 210 can include rounding rules, rules conditioned on past vendor-specific behaviors, behavioral economics experiments that are designed to evaluate what NTE policies affect vendor behavior, and/or measurement experiments that are designed to evaluate the impact (e.g., vendor invoice savings, vendor quote rate reductions, or other potential outcomes) of the disclosed automated NTE recommendation process as compared to the traditional NTE setting process, for example, although any other type of business rule can also be applied to the baseline quote rate in other examples. Business rules 210 can be enterprise-specific or applicable to all enterprises having a facility management system 106 in communication with the work order analysis server device 102.

In step 712, the work order analysis server device 102 returns the prescribed NTE limit in response to the NTE limit request received in step 704. The prescribed NTE limit can be received by the facility management system 106 as described and illustrated above with reference to step 306 of FIG. 3, and used by the facility management system 106 as explained above with reference to steps 308-316. Subsequent to returning the prescribed NTE limit, the work order analysis server device 102 proceeds back to step 704 and again waits to receive an NTE limit request. In some examples, steps 706-712 can be performed in parallel for any number of NTE limit requests received by the work order analysis server device 102 from any number of facility management systems associated with any number of enterprises.

As described and illustrated by way of the examples herein, this technology provides an improved work order analysis server device 102 that more effectively generates NTE limits to facilitate automated work order and vendor invoice or quote processing at facility management systems. This technology trains a machine learning model based on historical invoice data, and leverages tolerance data for particular enterprises and work order data relating to the service to be provided along with other contextual information, to generate an optimal prescribed NTE limit that achieves enterprise objectives when applied by a requesting facility management system.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for automated work order not-to-exceed (NTE) limit optimization, the method implemented by one or more work order analysis server devices and comprising:
training a machine learning model based on historical invoice data and a plurality of potential target quote rates for a plurality of enterprises and future scenarios, wherein the historical invoice data comprises an amount and associated contextual data for a plurality of invoices issued to the enterprises by service providers in response to service requests;
generating a baseline quote rate for an enterprise based on a plurality of historical invoices, quotes, and NTE values associated with the enterprise;
generating a target quote rate for the enterprise based on the baseline quote rate, tolerance data for the enterprise, and a first set of business rules, wherein the tolerance data comprises a quantitative indication of an efficiency preference of the enterprise with respect to work order review;
applying the machine learning model to the target quote rate and work order data extracted from an NTE limit request received from the enterprise to generate a model-recommended NTE limit; and
returning a prescribed NTE limit in response to the NTE limit request to facilitate automated processing of an electronic vendor quote, wherein the prescribed NTE limit is generated based on an application of a second set of business rules to the model-recommended NTE limit.

2. The method of claim 1, further comprising generating the tolerance data for the enterprise based on one or more of other historical invoice data for the enterprise, stored NTE limit data for the enterprise, or obtained industry benchmark data.

3. The method of claim 1, wherein one or more of the contextual data for each of the invoices or the work order data in the NTE limit request comprises one or more of a service specialty, a task, temporal data, or a geographic location.

4. The method of claim 1, wherein the quantitative indication of an efficiency preference comprises a percentage and the method further comprises determining a lowest vendor invoice amount on a curve of an invoice amount distribution that corresponds to the percentage, wherein the lowest vendor invoice amount corresponds to the model-recommended NTE limit.

5. The method of claim 1, wherein the NTE limit request is received via one or more communication networks, at an endpoint of a limit generator application executed by one of the work order analysis server devices, and from a work order management application executed by a facility management system associated with the enterprise.

6. The method of claim 1, wherein the efficiency preference corresponds to a level of monetary or time savings and the method further comprises receiving the tolerance data from a work order management application executed by a facility management system associated with the enterprise.

7. A work order analysis server device, comprising memory comprising programmed instructions stored thereon and one or more processors configured to execute the stored programmed instructions to:
train a machine learning model based on historical invoice data and a plurality of potential target quote rates for a plurality of enterprises and future scenarios, wherein the historical invoice data comprises an amount and associated contextual data for a plurality of invoices issued to the enterprises by service providers in response to service requests;
generate a baseline quote rate for an enterprise based on a plurality of historical invoices, quotes, and NTE values associated with the enterprise;
generate a target quote rate for the enterprise based on the baseline quote rate, tolerance data for the enterprise, and a first set of business rules, wherein the tolerance data comprises a quantitative indication of an efficiency preference of the enterprise with respect to work order review;
apply the machine learning model to the stored target quote rate and work order data extracted from an NTE limit request received from the enterprise to generate a model-recommended NTE limit; and
return a prescribed NTE limit in response to the NTE limit request to facilitate automated processing of an electronic vendor quote, wherein the prescribed NTE limit is generated based on an application of a second set of business rules to the model-recommended NTE limit.

8. The work order analysis server device of claim 7, wherein the processors are further configured to execute the stored programmed instructions to generate the tolerance data for the enterprise based on one or more of other historical invoice data for the enterprise, stored NTE limit data for the enterprise, or obtained industry benchmark data.

9. The work order analysis server device of claim 7, wherein one or more of the contextual data for each of the invoices or the work order data in the NTE limit request comprises one or more of a service specialty, a task, temporal data, or a geographic location.

10. The work order analysis server device of claim 7, wherein the quantitative indication of an efficiency preference comprises a percentage and the processors are further configured to execute the stored programmed instructions to determine a lowest vendor invoice amount on a curve of the invoice amount distribution that corresponds to the percentage, wherein the lowest vendor invoice amount corresponds to the model-recommended NTE limit.

11. The work order analysis server device of claim 7, wherein the NTE limit request is received via one or more communication networks, at an endpoint of a limit generator application executed by the work order analysis server device, and from a work order management application executed by a facility management system associated with the enterprise.

12. The work order analysis server device of claim 7, wherein the efficiency preference corresponds to a level of monetary or time savings and the processors are further configured to execute the stored programmed instructions to receive the tolerance data from a work order management application executed by a facility management system associated with the enterprise.

13. A non-transitory computer readable medium having stored thereon instructions for automated work order not-to-exceed (NTE) limit optimization comprising executable code which when executed by one or more processors, causes the processors to:
train a machine learning model based on historical invoice data and a plurality of potential target quote rates for a plurality of enterprises and future scenarios, wherein the historical invoice data comprises an amount and associated contextual data for a plurality of invoices issued to the enterprises by service providers in response to service requests;
generate a baseline quote rate for an enterprise based on a plurality of historical invoices, quotes, and NTE values associated with the enterprise;
generate a target quote rate for the enterprise based on the baseline quote rate, tolerance data for the enterprise, and a first set of business rules, wherein the tolerance data comprises a quantitative indication of an efficiency preference of the enterprise with respect to work order review;
apply the machine learning model to the stored target quote rate and work order data extracted from an NTE limit request received from the enterprise to generate a model-recommended NTE limit; and
return a prescribed NTE limit in response to the NTE limit request to facilitate automated processing of an electronic vendor quote, wherein the prescribed NTE limit is generated based on an application of a second set of business rules to the model-recommended NTE limit.

14. The non-transitory computer readable medium of claim 13, wherein the executable code when executed by the processors further causes the processors to generate the tolerance data for the enterprise based on one or more of other historical invoice data for the enterprise, stored NTE limit data for the enterprise, or obtained industry benchmark data.

15. The non-transitory computer readable medium of claim 13, wherein one or more of the contextual data for each of the invoices or the work order data in the NTE limit request comprises one or more of a service specialty, a task, temporal data, or a geographic location.

16. The non-transitory computer readable medium of claim 13, wherein the quantitative indication of an efficiency preference comprises a percentage and the executable code when executed by the processors further causes the processors to determine a lowest vendor invoice amount on a curve of the invoice amount distribution that corresponds to the percentage, wherein the lowest vendor invoice amount corresponds to the model-recommended NTE limit.

17. The non-transitory computer readable medium of claim 13, wherein the NTE limit request is received via one or more communication networks, at an endpoint of a limit generator application executed by a work order analysis server device, and from a work order management application executed by a facility management system associated with the enterprise.

18. The non-transitory computer readable medium of claim 13, wherein the efficiency preference corresponds to a level of monetary or time savings and the executable code when executed by the processors further causes the processors to receive the tolerance data from a work order management application executed by a facility management system associated with the enterprise.
